(19) United States
(12) Patent Application Publication
(10) Pub. No.: US 2025/0096513 A1
(43) Pub. Date: Mar. 20, 2025

(54) Socket for a Light Bulb Inserted with Axial and/or Rotational Forces

(71) Applicant: Wintergreen Corporation, Alpharetta, GA (US)

(72) Inventors: William Hale, Cumming, GA (US); Richard Chitwood, Cumming, GA (US)

(73) Assignee: Wintergreen Corporation, Alpharetta, GA (US)

(21) Appl. No.: 18/888,932

(22) Filed: Sep. 18, 2024

Related U.S. Application Data
(60) Provisional application No. 63/539,230, filed on Sep. 19, 2023.

(51) Int. Cl. H01R 33/90; H01R 33/22; H01R 33/46

(52) U.S. Cl. CPC H01R 33/90; H01R 33/22; H01R 33/46

(57) ABSTRACT

A light bulb socket having a configuration which permits bulb insertion by application of axial force, such as required with a bayonet type bulb, and also by application of rotational forces, such as a traditional threaded bulb. The socket includes a generally cylindrical sidewall, upper or proximal flex flanges forming generally parallel ribs along the inwardly facing surface of the sidewall, and a bottom or distal flange which or may not be flexible. The socket sidewall defines, on an inwardly facing surface, a sidewall cavity positioned radially outwardly or behind at least a portion of the upper flex flanges.

### CROSS REFERENCE TO RELATED APPLICATION

This application claims priority to U.S. Provisional Application No. 63/539,230 filed Sep. 19, 2023, the disclosure of which is hereby incorporated by reference.

### FIELD OF THE INVENTION

The present invention relates generally to a light bulb socket enabling a light bulb to be inserted selectively by axial force and/or rotational forces. More specifically, the socket enables screw fitted bulbs, such as Edison screw style/type conventionally inserted with rotational forces, to be inserted using axial forces. As such, they are inserted as a force driven light bulb, permitting insertion by either method in the same socket to achieve electrical connectivity.

### BACKGROUND OF THE INVENTION

Installation and removal of a conventional threaded light bulb into a conventional threaded socket, although well accepted for achieving electrical connectivity, is time consuming. The time involved and energy expended becomes excessive when considering installations involving numerous light bulbs, such as string lights and commercial lighting installations. A socket is intended to secure a light bulb into the socket of the lighting fixture (light strand or other fixture) and to conduct electric current through a positive terminal and a neutral terminal of the bulb to achieve illumination. As such, it is imperative that the design of the socket facilitate this electrical connection.

An example of a light socket enabling both bayonet (or other force-driven) light bulbs and screw fitted bulbs is U.S. Pat. No. 10,794,574 which utilizes a bulb interface comprising flanges formed of a material and flange profile having a predetermined hardness to provide sufficient flexibility of the inwardly facing flange surface depending upon the tolerances provided. The predetermined flexibility of the flanges and design of the light socket provides for a threaded bulb to be inserted into the cavity of the socket with the application of appropriate distal axial force to displace the inwardly facing surface of the flanges and to urge the flanges axially outward and/or distally for insertion of the bulb. The flanges have a predetermined hardness to nonetheless secure the threads of the bulb to prevent unintentional removal of the bulb. The configuration requires sufficient axial forces in the proximal direction to remove the bulb.

### SUMMARY OF THE INVENTION

Presented herein is a light bulb socket having a configuration which permits bulb insertion by application of axial force, such as required with a bayonet type bulb, and also by application of rotational forces, such as a traditional threaded bulb. The benefits of having a socket configured to receive and to electrically connect both types of bulbs is beneficial in many aspects and provides a socket having increased utility while also selectively complying with UL recognitions and ANSI standards when needed.

The socket includes a generally cylindrical sidewall, upper or proximal flex flanges forming generally parallel ribs along the inwardly facing surface of the sidewall, and a bottom or distal flange which or may not be flexible. It is within the scope of the invention to provide additional, non-flexible rib or ribs in addition to the flex flange. The socket sidewall defines, on an inwardly facing surface, a sidewall cavity positioned radially outwardly or behind at least a portion of the upper flex flanges. This configuration provides a radial displacement area within which the upper flex flanges may be urged and flexed into (that is, radially outward) when a bulb is inserted with axial, distal forces. Upon insertion of the bulb, the upper flex flanges will revert back to their original position and engage the threads of the bulb. Thus, the flanges are urged radially outwardly during bulb inserted under distal, axial force, but revert back (at least to a degree permitted by the inserted bulb) to a position generally radially inward of (e.g., in front of) the sidewall aperture to engage and retain the bulb in the socket and to achieve electrical connectivity. Alternatively, if a bulb is inserted with rotational forces, the threads of the lightbulb will engage the proximal flanges and the bulb may be rotated for insertion, thus not substantially involving the sidewall cavity because the flanges will not be urged and displaced radially outward.

In one aspect, the proximal flanges extend across the sidewall cavity and are secured to the sidewall on opposing sides of the sidewall cavity. In another aspect, the flanges are supported on a flexible wall which is connected either to the top of the cavity or the bottom of the sidewall cavity and wherein the wall is cantilevered in front of, radially inward of, the sidewall cavity. Thus, axial forces from the bulb will cause the wall and, thus, the flanges to deflect radially outward into the sidewall cavity and then revert back after the bulb is inserted. If rotational forces are employed, the wall is not significantly urged into the sidewall cavity and the flanges supported on the wall engage with the bulb inserted with rotational forces.

According to various aspects, a distal flange is provided distal to the proximal flanges and circumferentially offset from the upper flanges or aligned circumferentially therewith. The upper flange includes at least one, or two or more parallel flex flanges, which extend circumferentially around a predetermined length of the side wall circumference. The bottom flange is positioned on the sidewall, distal to the one or more upper flex flanges, parallel thereto, but circumferentially offset from the upper flex flanges. This configuration permits a bulb inserted with axial forces to then be slightly rotated to engage the bottom flange to secure the bulb against axial forces and to meet UL Standards permitting unintentional withdrawal under proximal axial forces. The bottom flange may or may not be flexible. It is within the scope of the present invention for the two (or more) proximal flex flanges to have different configurations, dimensions (e.g., extend radially inward different distances), and formed of different materials. Similarly, the distal flange may have different configurations, dimensions (e.g., extend radially inward different distances), and formed of different materials than one, some, or all of the proximal flex flanges. And finally, more than one distal flange may be provided.

### BRIEF DESCRIPTION OF THE DRAWINGS

FIG. 1 is a cross-section, perspective view of a socket according to one aspect;

FIG. 2 is an enlarged, perspective view showing the flex flanges and sidewall cavity of the sidewall according to FIG. 1;

FIG. 3 is a top perspective view of the socket of FIG. 1;

FIG. 4 is a top, enlarged perspective view of the socket according to another aspect wherein a flex wall supports the upper flanges;

FIG. 5 is a cross sectional view of the socket according to various aspects having a bulb inserted therein;

FIG. 6 is a cross-section, perspective view of a socket according to FIG. 1 including a post within the displacement cavity; and

FIGS. 7A and 7B are perspective views of an upper flange according to another aspect of the invention.

### DETAILED DESCRIPTION OF THE INVENTION

The present invention is understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes are made to the aspects described, while still obtaining the beneficial results of the present invention. It will also be apparent that some of the desired benefits of the present invention is obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “tether” includes aspects having two or more tethers unless the context clearly indicates otherwise.

Ranges is expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. As used herein, the term “generally” is used to identify a “general” feature which best describes the feature, even if it is not exact. For example, “generally cylindrical” does not define a precise cylindrical geometric configuration but a configuration that approximates a cylinder.

As used herein, the terms “optional” or “optionally”, “selected” or “selectively” mean that the subsequently described event or circumstance may or may not occur, and that the description includes instances where said event or circumstance occurs and instances where it does not.

As used herein, the terms “proximal” and “distal” (excluding horizontal cross-sections) are used to refer to the axial ends of the socket and various components. The term “proximal end” refers to the end closely adjacent the socket opening for receipt of the bulb and the term “distal end” refers to the end of the socket for connecting to a wire. Also, as used herein, the “axial direction” refers to the longitudinal axis of the socket, parallel to the center thereof. The term “transverse” direction refers to a direction which intersects the longitudinal axis, at any angle. The term “radial to”, “radially”, “radially inward”, or “radially outward” refers to a direction transverse to the longitudinal axis of the socket; that is inward and outward from the socket central longitudinal axis. “Circumferential length” refers to a distance, along the sidewall, extending generally horizontal around the sidewall, transverse to the longitudinal axis.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

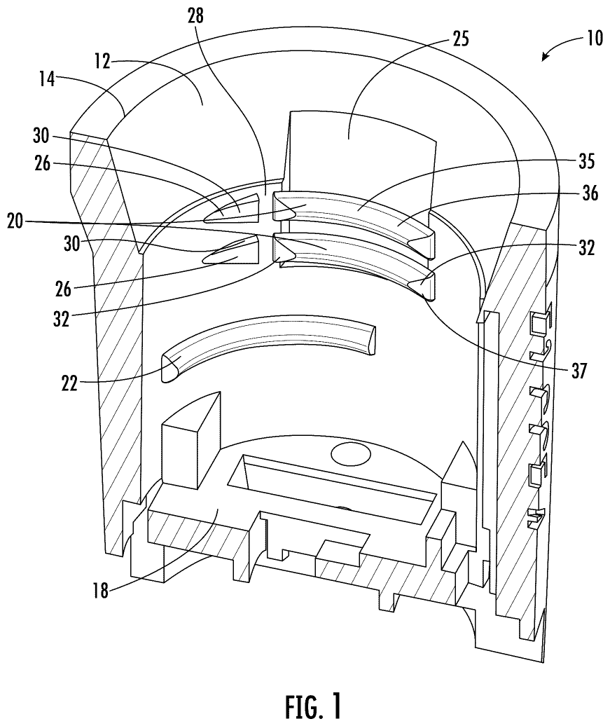

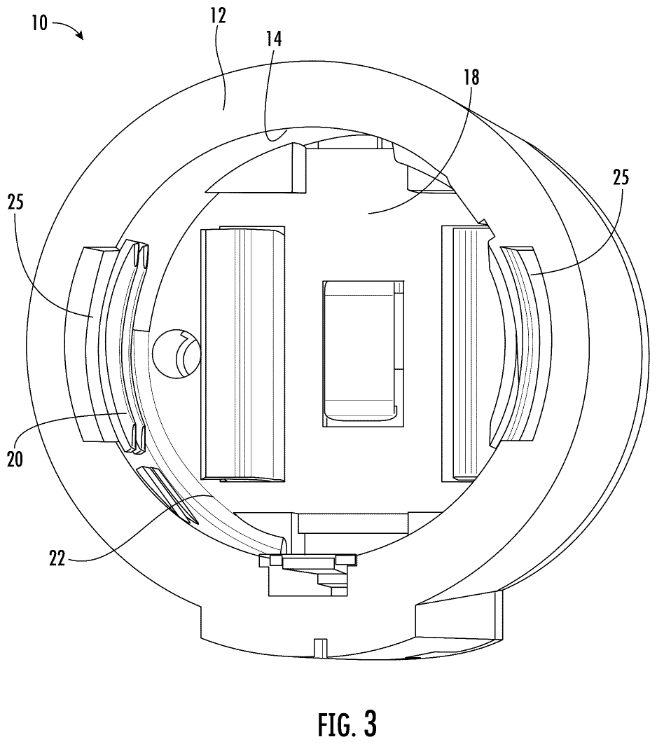

FIGS. 1 and 3 illustrate the socket 10 according to the present invention which includes a generally cylindrical sidewall 12, a proximal opening 14 configured for receipt of a bulb 15, and a distal bottom surface 18 configured for connection to an electrical source (not shown). The sidewall 12 supports at least one, and as shown two, proximal flex flanges 20 and a distal flange 22. As shown in FIGS. 1 and 3, proximal flex flanges 20 each include a detached end ramp 26 and a gap 28 defined between the end ramp 26 and flex flange 20. It is within the scope of the present invention, however, for the gap 28 not be therebetween wherein the end ramp 26 forms the left end of the flex flange 20. It is also within the scope of the present invention for there to be just one end ramp 26 and for the end ramp to be non-flexible and, thus, extend radially inward a shorter distance that the proximal flex flange 20. As shown, the ramp 26 includes an inwardly facing ramp inner surface 30 having a slope of between less than 40° and more specifically, less than 25°, such as 16°. The distance inwardly is, according to one aspect, less than the radial inward distance of the flex flange 20, at least along the ramp inner surface 30. The flex flanges 20 include a left and right-side end defining a sloped end surface 32. The ramp inner surface 30 cooperates with the adjacent left sloped end surface 32. According to one aspect, the respective slopes are contiguous to permit smooth rotation of the bulb as described below. According to another aspect, the slopes may be the same or the slope may not be contiguous, that is, it is flat, with no slope. Of course, if the gap 28 is not provided, the flex flange 20 and ramp 26 would form a unitary flex flange 20. According to one aspect, the ramp 26 extends radially inward a distance substantially equal to or less than the tolerances of the bulb 15 within the socket 10 to permit bulb 15 insertion by axial distal forces. The outermost point of the ramp (away from flex flange 20) is configured so the ramp top edge engages the bottom quadrant of the bulb interface 18 thread. The flex flange 20 extends radially inward a distance equal to or greater than tolerances between the bulb 15 and sidewall 12 to either engage the flex flanges 20 under rotational forces or to radially displace the flex flanges 20 into the sidewall cavity 25 under axial forces (proximal for removal and distal for insertion). The flex flanges 20 extend radially inward a distance compliant with ANSI specification for the maximum and minimum diameter of the bulb interface 18.

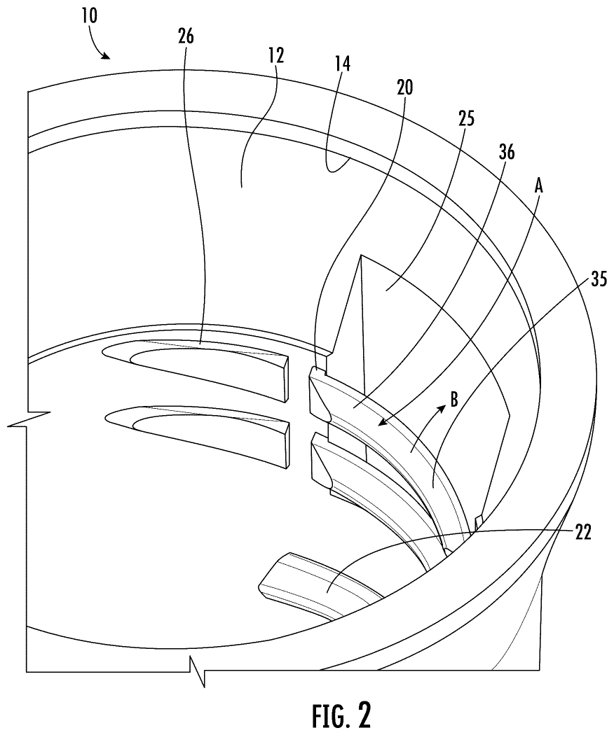

The sidewall 12 defines a sidewall cavity 25 located radially outward, that is, behind, the flex flanges 20. The flex flange ends 32 are secured to the sidewall 12 of the socket 10. A medial portion 35 of each flex flange spans across or radially inward of, the sidewall cavity 25 as shown in FIGS. 1, 2 and 3. The flex flange medial portion 35 includes a sloped upper surface 36 and bottom surface 37 as best shown in FIGS. 1 and 2. The flex flange 20 are wider than the circumferential width of the sidewall cavity 25. The flex flanges 20, as shown, extend circumferentially along the sidewall inner surface at a pitch consistent with ANSI standards for receipt of an Edison light bulb, such as 0.1111″ pitch.

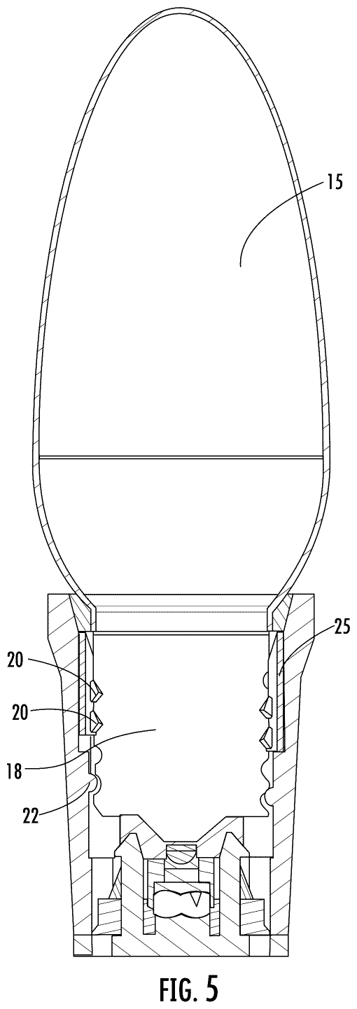

As shown in FIG. 2, when downward axial force A is applied to each of the flex flanges 20 such as occurs when a bulb 15, having threaded bulb interface 48, is pushed distally into the socket 10, it first encounters the upper surface 36 of the uppermost flex flange 20, and the flex flange 20 is displaced radially outward in the direction B into the sidewall cavity 25. The bulb 15 then encounters the second (and any subsequent) flex flange 20 which likewise is displaced radially outward into the sidewall cavity 25. Upon further distal axial forces applied to the bulb 15, the bulb thread encounters the distal flange 22 and an at least partial rotation of the bulb 15 would engage the distal flange 22 with the bulb threads for the bulb to be fully seated. Once fully inserted, the flex flange 20 reverts inward to engage the bulb thread as shown in FIG. 5.

As shown in FIG. 1, one aspect of the present invention is directed to a light socket 10 having at least one proximal flange 20 for engaging the light bulb 15 and permitting insertion of the bulb 15 by axial and/or rotational forces and a longitudinally distanced distal flange 22 as described herein. Thus, there is portion of the sidewall 12 between the lower most or only proximal flange 20 and distal flange 22, as shown in FIG. 1, which is void of a flange to mate with the bulb 15 threads. Conventional light sockets have a series of continuous, equally spaced threads to mate with the threads of a bulb. However, the present invention provides a novel cylindrical sidewall 12 which mates with a threads of a conventional bulb 15, but which has a sidewall section, in the longitudinal direction, between flanges, such as the lower most or singular proximal flange 20 and distal flange 22. As shown, this distance is a predetermined distance at least equal to or greater than two times the longitudinal height of the lower most flange 20. This section is substantially void of a flange.

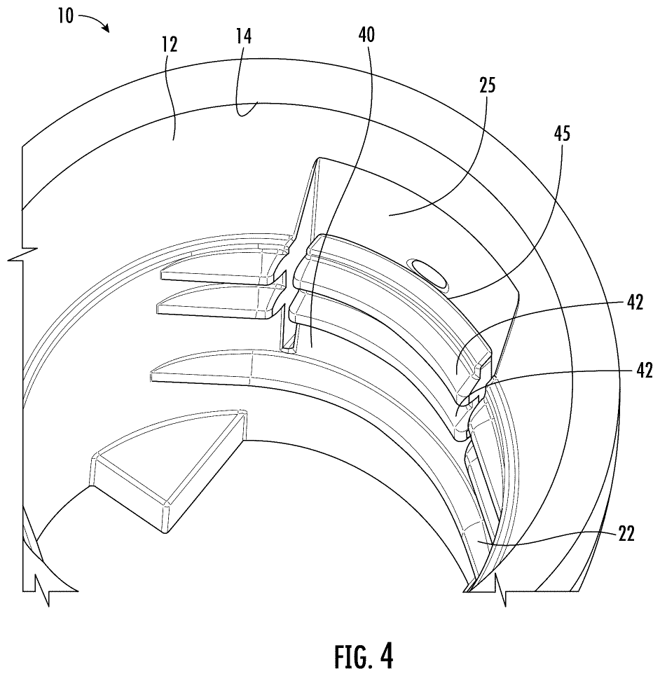

As shown in FIG. 4, according to one aspect of the present invention, a cantilevered wall 40 supports the proximal flex flange 42 or flanges 42. As shown, the cantilevered wall 40 includes a base wall connected to the sidewall 12 and a terminal wall 45. FIG. 4 illustrates the wall 40 extending from the bottom of the sidewall cavity 25 but it is within the scope of the present invention (not shown) for the base wall to extend from a top edge or sidewalls of the sidewall cavity 25 and the terminal wall 45 to form the bottom edge of the cantilevered wall 45.

Also, according to the aspect show in FIG. 4, each flex flange 42 selectively includes at least one, or as shown a pair, of ramps 26 on opposing sides. It is within the scope of the present invention, however, not to include one or two ramps 26. The ramps 26 may also be substantially flat, that is not sloped. The ramps 26 extend from the side edges of the sidewall cavity 25 and are configured as described above regarding FIG. 1. According to FIG. 4, however, the ramps 26 are positioned immediately adjacent the sidewall cavity side edges.

A distal flange 22 is also supported on the inwardly facing surface of the sidewall 12. The distal flange 22, as shown, extends circumferentially along the sidewall 12 inner surface (for example, a pitch of 0.1111″). According to one aspect, the distal flange 22 is configured to mate with the threaded bulb interface 18. According to another aspect, the distal flange 22 defines a sloped upper surface.

When the light bulb 15 is inserted into the socket 10 either by engaging the proximal flex flange 20 or flanges 20 by application of rotational forces or distal axial forces, (i.e., pushed), the threaded bulb interface 18 engages with the distal flange 22. Rotation clockwise of the light bulb 15 will result in the bulb interface 18 threads to further seat with the distal flange 22 and secure the bulb 15. As such, even proximal distal forces applied to the bulb 15 will not likely cause the bulb 15 to be pulled out of the socket, thus complying with relevant UL Standards. Slight rotation of the bulb in the other direction removes the bulb interface 18 threads from the distal flange 22 (above the distal flange 22), permitting withdrawal with upward axial force wherein the flex flanges 20 will displace into the sidewall cavity 25 as described above. The bulb 15 may then be fully remove with axial force. Of course, continued rotational forces will also result in the bulb 15 being removed as the bulb interface 18 cooperates with the flex flanges 20 to remove the bulb 15 under rotational forces.

According to one aspect of the present invention as shown in FIGS. 1, 2 and 3, the distal flange 22 is offset from the flex flanges 20. As used herein “offset” refers to the position of the distal flange 22 relative to the flex flanges 20 wherein the flanges are not aligned longitudinally. As shown in FIG. 1, the distal flange 22 is positioned with its left end circumferentially to the left from the left end of the flex flanges 20. It is within the scope of the invention, to shift the distal flange 22 to the right as well. While not intending to be bound by any particular theory, it is believed that the offset distal flange 22 beneficially facilitates engagement of the bulb threads to the distal flange 22. As shown in FIG. 4, the distal flange 22 and flex flanges 20 are aligned, that is, not offset. According to all aspects of the present invention, the distal flange 22 is selectively aligned or offset from the flex flanges 20.

The distal flange 22 shown in the various Figures is supported on the socket sidewall 12. It is within the scope of the present invention to provide a flex distal flange 22 wherein a sidewall cavity is provided radially outward of (behind) the distal flange 22 similar to the flex flanges 20 of FIGS. 1 and 4.

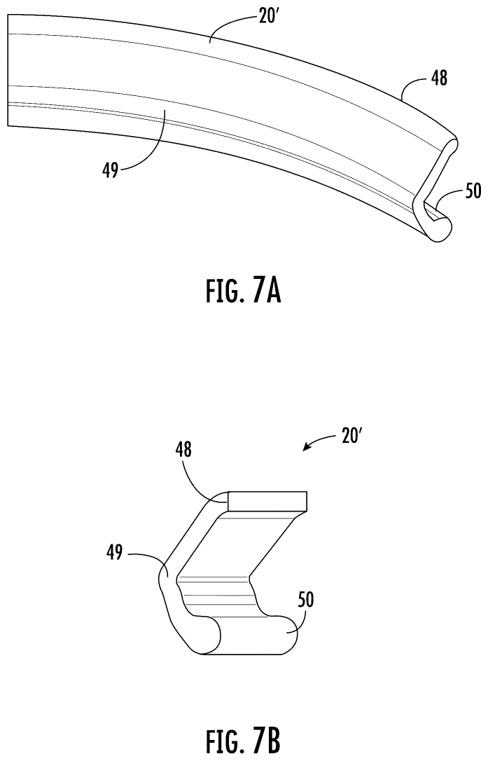

FIGS. 7A and 7B illustrate an alternative flex flange 20′ which may be utilized in the socket shown in FIG. 1 and FIG. 4. The flex flange 20′ is cantilevered from the sidewall 12 having a top member 48 secured to the sidewall 12, a medial portion 49 forming a thread configured to mate with the bulb thread, and a bottom edge 50 which is not secured to the sidewall. The bottom edge 50 urges against the sidewall 12, and when used with a sidewall cavity 25 it extends into the cavity 25, but is not affixed thereto, enabling threading of the bulb onto the flex flange 20′ with rotational applied forces. Alternatively, the top edge of the flex flange 20′ may be cantilevered with the bottom edge 50 affixed to the sidewall 12 or cantilevered wall 40. Under axial forces, the flex flange 20′ is configured to collapse into the cavity 25 as described above.

The flex flanges 20, 20′ and distal flange 22 may be fabricated of a material, such as an extruded, thermoplastic material, having the desired hardness to facilitate threading of the flange 20, 20′, 22 with the bulb interface 18. The material selected for the flex flanges 20, 20′ is selected with a hardness permitting movement of the flange 20 radially outward into the cavity 25 as described above. All selected materials meet requisite fire rating standards.

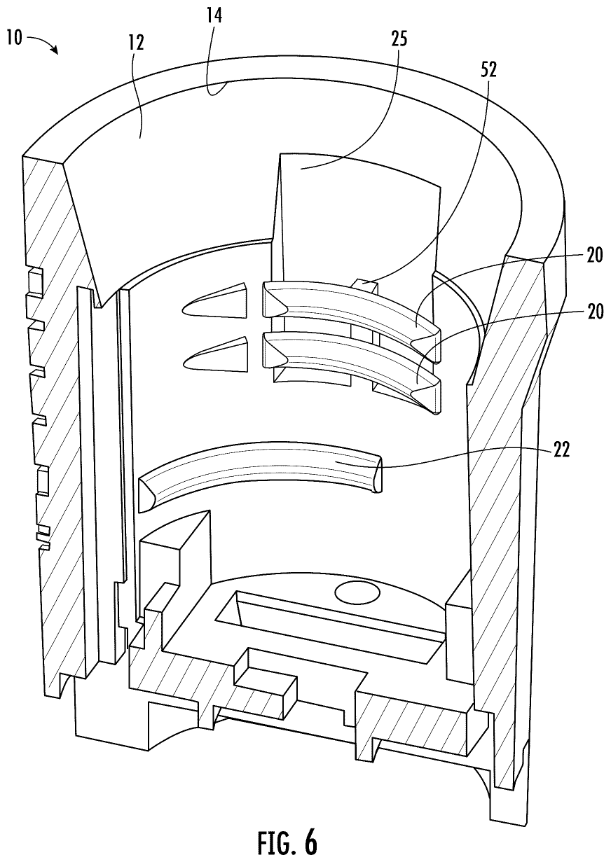

FIG. 6 illustrates an aspect of the present invention which includes a post 52 extending upwardly from the bottom edge of the sidewall cavity 25 and behind (radially outward from) the flex flanges 20. The post 52 beneficially provides support to the flex threads during manufacturing.

While exemplary embodiments have been shown and described above for the purpose of disclosure, modifications to the disclosed embodiments may occur to those skilled in the art. The disclosure, therefore, is not limited to the above precise embodiments and that changes may be made without departing from its spirit and scope.

What is claimed is:

1. A socket for receiving a light bulb inserted with use of axial force and rotational force, the socket comprising:
a generally cylindrical sidewall having a proximal opening wherein said sidewall defines a socket receiving cavity;
at least one proximal flange extending a predetermined circumferential distance along said sidewall longitudinally below said proximal opening and extending radially inwardly from said sidewall within said socket receiving cavity; and
a sidewall cavity defined by said sidewall adjacent said at least one proximal flange wherein said sidewall cavity extends radially outwardly from said socket receiving cavity and wherein at least a portion of said at least one proximal flange is moveable from a first position to a second position wherein said second position is radially outward from said first position and said at least a portion of said at least one proximal flange in said second position extends radially outward into said sidewall cavity under axial force.

2. The socket according to claim 1 wherein said sidewall includes a ramp which extends generally co-linearly with said at least one proximal flange along said sidewall.

3. The socket according to claim 2 wherein said ramp is circumferentially remote from said at least one proximal flange.

4. The socket according to claim 1 wherein said at least one proximal flange has a sloped upper surface with a slope extending downward relative to a longitudinal axis of said socket receiving cavity.

5. The socket according to claim 1 wherein said at least one proximal flange includes flex flange ends secured to said sidewall and a medial portion which is positioned on said sidewall so as to extend across said sidewall cavity wherein said medial portion of said at least one proximal flange is moveable from said first position to said second position to extend within said sidewall cavity under axial forces.

6. The socket according to claim 1 further comprising a distal flange extending a predetermined circumferential distance along said sidewall longitudinally below said at least one proximal flange and extending radially inwardly from said sidewall within said socket receiving cavity.

7. The socket according to claim 6 wherein said distal flange is circumferentially offset from said at least one proximal flange wherein rotational forces are applied to the light bulb to engage said distal flange.

8. The socket according to claim 1 wherein sidewall includes a second proximal flange extending along said sidewall longitudinally below said at least one proximal flange, radially inwardly from said sidewall within said socket receiving cavity, and generally parallel to said at least one proximal flange.

9. The socket according to claim 8 wherein said second proximal flange extends along said sidewall a predetermined circumferential distance substantially equal to said at least one proximal flange.

10. The socket according to claim 8 wherein said second proximal flange includes flex flange ends secured to said sidewall and a medial portion which is positioned on said sidewall so as to extend across said sidewall cavity wherein said medial portion of said second proximal flange is moveable from said first position to said second position to extend within said sidewall cavity under axial forces.

11. The socket according to claim 1 wherein said sidewall further comprises a cantilevered wall which moves from a first position generally radially parallel to said sidewall to a second position wherein at least a portion of said cantilevered wall extends within said sidewall cavity radially inwardly of said sidewall and wherein said at least one proximal flange is supported on said cantilevered wall.

12. The socket according to claim 11 wherein said cantilevered wall has a distal portion connected to said sidewall and a proximal portion that moves from said cantilevered wall first position to said cantilevered wall second position.

13. The socket according to claim 11 wherein said cantilevered wall includes a second proximal flange extending along said cantilevered wall longitudinally below said at least one proximal flange, radially inwardly from said sidewall within said socket receiving cavity, and generally parallel to said at least one proximal flange.

14. The socket according to claim 11 further comprising a distal flange extending a predetermined circumferential distance along said sidewall longitudinally below said at least one proximal flange and extending radially inwardly from said sidewall within said socket receiving cavity.

15. The socket according to claim 1 wherein said at least one proximal flange includes a flex flange horizontal connecting edge secured to said sidewall and a second horizontal edge, substantially parallel to said flex flange horizontal connecting edge which is positioned on said sidewall so as to extend across said sidewall cavity wherein said second horizontal edge of said at least one proximal flange is moveable from said first position to said second position to extend within said sidewall cavity under axial forces.

16. A method of inserting a light bulb into a socket with use of axial force and rotational force, the socket comprising a generally cylindrical sidewall having a proximal opening wherein said sidewall defines a socket receiving cavity, at least one proximal flange extending a predetermined circumferential distance along said sidewall longitudinally below said proximal opening and extending radially inwardly from said sidewall within said socket receiving cavity, and a sidewall cavity defined by said sidewall adjacent said at least one proximal flange wherein said sidewall cavity extends radially outwardly from said socket receiving cavity and wherein at least a portion of said at least one proximal flange is moveable from a first position to a second position wherein said second position is radially outward from said first position and said at least a portion of said at least one proximal flange in said second position extends radially outward into said sidewall cavity under axial force, the method comprising the steps of:
inserting the light bulb into the socket using axial forces.

17. The method according to claim 16 further comprising the step of applying rotational forces to the light bulb after said step of inserting the light bulb using axial forces.

18. A socket for receiving a light bulb inserted with use of axial force and rotational force, the socket comprising:
a generally cylindrical sidewall having a proximal opening wherein said sidewall defines a socket receiving cavity;
at least one proximal flange extending a predetermined circumferential distance along said sidewall longitudinally below said proximal opening and extending radially inwardly from said sidewall within said socket receiving cavity;
a distal flange extending a predetermined circumferential distance along said sidewall longitudinally below said at least one proximal flange and extending radially inwardly from said sidewall within said socket receiving cavity. and
wherein a portion of said cylindrical sidewall includes a longitudinal section defined between said at least one proximal flange and said distal flange which is substantially void of a flange for mating with the light bulb, wherein said longitudinal section is at least equal to, in the longitudinal direction, a flange height measured in the longitudinal direction.
